(19) United States
(12) Patent Application Publication
(10) Pub. No.: US 2022/0259461 A1
(43) Pub. Date: Aug. 18, 2022

(54) REPOSITIONABLE PEEL-AND-STICK EMBELLISHED WALL COVERINGS

(71) Applicant: Brewster Home Fashions LLC, Randolph, MA (US)

(72) Inventors: Paul H. Feinstein, Weston, MA (US); Gary M. Katz, Marblehead, MA (US); Yuanchen Stanley Wang, Westwood, MA (US)

(21) Appl. No.: 17/591,159

(22) Filed: Feb. 2, 2022

Related U.S. Application Data
(60) Provisional application No. 63/234,918, filed on Aug. 19, 2021.
(60) Provisional application No. 63/144,787, filed on Feb. 2, 2021.

(51) Int. Cl. C09J 7/21; B41M 3/18; C09J 7/30

(52) U.S. Cl. CPC C09J 7/21; C09J 2431/00; C09J 7/30; B41M 3/18

(57) ABSTRACT

A repositionable peel-and-stick embellished wall covering is formed by a process including providing a repositionable peel-and-stick wall covering substrate having one or more layers of material with a front surface and with a self-adhesive backing covered by a peelable backing material; adding a base design to the front surface of the substrate; adding embellishments to the front surface over the base design, the embellishments including at least one of string, grasscloth, beads, or flock; and drying the wall covering.

### CROSS-REFERENCE TO RELATED APPLICATION(S)

This patent application claims the benefit of United States Provisional Patent Application No. 63/234,918 entitled REPOSITIONABLE PEEL-AND-STICK EMBELLISHED WALL COVERINGS filed Aug. 19, 2021 and also claims the benefit of U.S. Provisional Patent Application No. 63/144,787 entitled REPOSITIONABLE PEEL-AND-STICK EMBELLISHED WALL COVERINGS filed Feb. 2, 2021, each of which is hereby incorporated herein by reference in its entirety.

### FIELD OF THE INVENTION

The invention generally relates to repositionable peel-and-stick wallcoverings.

### BACKGROUND OF THE INVENTION

Repositionable peel-and-stick wall coverings have become a popular option for wallpaper and other wall decorations due to their relative ease of installation (e.g., essentially just peel and stick) and the ability to remove and reuse/reposition such wall coverings. Generally speaking, current repositionable peel-and-stick wall coverings have one or more layers of material (e.g., vinyl or paper) with a self-adhesive backing covered by a peelable backing material (e.g., backing paper). The front surface is typically printed or embossed with a desired design.

The following is a list of some potentially relevant prior art:
U.S. Pat. No. 6,500,775.
U.S. Pat. No. 6,627,284.
U.S. Patent Application Publication No. 2005/0233662.
U.S. Patent Application Publication No. 2011/0035340.
U.S. Patent Application Publication No. 2016/0075118.
Japanese Patent Application/Publication JP3035936U.
UK Patent Application/Publication GB2555520A1.
UK Patent Application/Publication GB2191731A1.
PCT Published Patent Application No. WO2004037545.

### SUMMARY OF VARIOUS EMBODIMENTS

In accordance with one embodiment of the invention, a process for creating a repositionable peel-and-stick embellished wall covering includes providing a repositionable peel-and-stick wall covering substrate having one or more layers of material with a front surface and with a self-adhesive backing covered by a peelable backing material, adding a base design to the front surface of the substrate, adding embellishments to the front surface over the base design including at least one of string, grasscloth, beads, or flock, and drying the wall covering.

In various alternative embodiments, the substrate may include a removable facing material (e.g., 5 mil vinyl) that is adhered to a backing liner (e.g., a 50# backing liner) using a removable/repositionable backing adhesive (e.g., H-802 adhesive). Adding a base design to the front surface of the substrate can include at least one of gravure printing, digital printing, or rotary screen printing a design with one or more inks (e.g., water-based inks) and drying, e.g., using hot air impingement and infrared dryers as the heat source. Adding the embellishments can include applying adhesive to the embellishments and then applying the embellishments with adhesive to the front surface over the base design and/or can include applying adhesive to the front surface over the base design and then applying the embellishments to the front surface with adhesive. The embellishments may include strings (e.g., up to around 27 strings per inch), in which case adding the embellishments may include running the substrate with base design through a string lamination press in which the strings are adhered to the front surface over the base design, e.g., by applying an adhesive to the strings and/or to the front surface, and drying the wall covering comprises using steam drums as the drying source under predetermined process conditions that allow for properly drying the strings and adhesive without damaging the backing liner and backing adhesive (e.g., wherein the steam drums are maintained at a temperature between around 220° F.-240° F. and the product is passed across the steam drums for a total dwell time at each point along the length of the product between around 20-30 seconds for sufficient drying). Adding the embellishments may include using a template for placement of the embellishments and/or using an adhesive that dries with a matte finish, e.g., a water-based white latex adhesive made from Polyvinyl Acetate (PVAC) or certain adhesives of the type that is often used in the garment industry to glue cloth with a sponge or silica gel. The base design may be chosen to match or complement the embellishment so that any spaces between embellishments are less noticeable. The substrate may be made at least in part from silicon coated paper pulp that is less susceptible to shrinking. Water may be applied to the substrate backing liner after a heating process so that the substrate backing liner can stay hydrated and flexible. An antifungal agent may be applied to at least one of the substrate or the embellishments to prevent mold. The completed wall covering may be rolled including an extra sheet of waterproof liner in order to avoid direct contact between the front of the product to the backing liner.

In accordance with one embodiment of the invention, a process for creating a repositionable peel-and-stick embellished wall covering includes dying the grasscloth to a desired color using natural dye; drying the grasscloth on heating cylinder; matching the print color to the dye; gravure printing the substrate; oven heating the product to dry the print; Applying water back to the liner to prevent creasing; applying adhesive to the printed surface; laminating the dyed grasscloth to the substrate; oven heating the product to dry the adhesive; applying water back to the liner to prevent creasing; and trimming the edge.

Embodiments also include repositionable peel-and-stick embellished wall coverings produced using any of the above processes.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a process flow diagram showing a general process for creating a repositionable peel-and-stick embellished wall covering in accordance with various embodiments.

FIG. 2 is a process flow diagram showing a specific process for creating a repositionable peel-and-stick grasscloth wall covering in accordance with various embodiments.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DESCRIPTION OF ILLUSTRATIVE EMBODIMENTS

Definitions. As used in this description and the accompanying claims, the following terms shall have the meanings indicated, unless the context otherwise requires.

The term “string” is generally given its convention meaning in the art of wall coverings as including one or more threads of natural or artificial material formed into a single strand as used on wall coverings. String can include yarn, twine, cord, wire, etc.

The term “grasscloth” is generally given its convention meaning in the art of wall coverings as including any of various types of grasses, fibers, leaves, or other natural materials (e.g., hemp, jute, sea grass, arrowroot grass, bamboo or other wood veneers, raffia, feathers, paper, etc.) or faux versions of such elements that generally are woven (e.g., by hand) into a wall covering material.

For purposes of this patent application, an “embellished” wall covering is a wall covering that includes string, grasscloth, beads, and/or flock added to the front surface.

The applicant/assignee and inventors are not aware of any repositionable peel-and-stick versions of embellished wall coverings on the market today such as repositionable peel-and-stick versions of string, grasscloth, beaded, and flock wall coverings. The applicant/assignee of this patent application is in the business of manufacturing and selling repositionable peel-and-stick wall coverings as well as embellished wall coverings and sought to provide repositionable peel-and-stick versions of embellished wall coverings for this unmet market segment. What the applicant/assignee found was that repositionable peel-and-stick embellished wall coverings are not as straightforward to produce as it might seem at first glance, in part because embellishments such as string, grasscloth, beads, and flock are generally added to the front surface after other surface treatments such as printing or embossing, which means that for repositionable peel-and-stick embellished wall coverings, such surface embellishments generally need to be added after the self-adhesive backing and peelable backing material are already in place.

Initial repositionable peel-and-stick embellished wall coverings envisioned by the applicant/assignee and inventors include repositionable peel-and-stick string wall coverings. Without limitation, certain exemplary embodiments of such repositionable peel-and-stick string wall coverings start with a repositionable peel-and-stick wall covering substrate having one or more layers of material (e.g., vinyl or paper) with a self-adhesive backing covered by a peelable backing material (e.g., backing paper). In one particular exemplary embodiment, the substrate includes a removable facing material (e.g., 5 mil vinyl) that is adhered to a backing liner (e.g., a 50# backing liner) using a removable/repositionable backing adhesive (e.g., H-802 adhesive). A base design is then added to the front surface, e.g., by gravure printing, digital printing, or rotary screen printing a design with one or more inks (e.g., water-based inks) and drying, e.g., using hot air impingement and infrared dryers as the heat source. Then, the product is run through a string lamination press in which an adhesive (e.g., V1816 neutral adhesive) is applied to strings (e.g., dyed 20/2 spun rayon) that are in turn applied to the facing material over the base design and dried using steam drums as the drying source under very precise process conditions that allow for properly drying the strings and adhesive without damaging the backing liner and backing adhesive. In certain exemplary embodiments, the steam drums are maintained at a temperature between around 220° F.-240° F. and the product is passed across the steam drums for a total dwell time at each point along the length of the product between around 20-30 seconds for sufficient drying. The total threads per inch of strings being laminated depends on the design of a particular wall covering and can be for example, around 27 threads per inch in some exemplary embodiments.

Of course, different product versions can be made from different facing materials (e.g., vinyl, paper, etc.), different backing liners (e.g., different weight liners), different adhesives, different inks and printing processes, and/or different types of strings, with appropriate adjustments of process parameters (e.g., amount of adhesive, drying temperature, dwell time, etc.) as needed.

It should be noted that rather than applying adhesive to the strings, alternative embodiments can apply adhesive to the facing material to which the strings are then adhered and dried.

The applicant/assignee and inventors envision similar processes and process parameters for other types of repositionable peel-and-stick embellished wall coverings such as grasscloth, bead, and flock wall coverings, e.g., adhering grasscloth, beads, or flock to the substrate substantially as described above for string, for example, by applying adhesive to the embellishment and/or to the front surface and then applying the embellishment and drying the adhesive through a heat-based process. Particularly for beads and flock, the process may use various types of templates for placement of beads and flock, e.g., a screen or other template for placing beads or a shadow mask for forming flock designs.

The applicant/assignee and inventors envision highly customizable products in which a customer will be able to, for example, choose such things as the substrate type and color, pattern to be printed or embossed on the substrate (e.g., either selected from a standard library of patterns or in some cases even provided by the customer such as in the form of a digital file to be printed), and embellishments (e.g., string types, colors, and pattern; beads and bead pattern; etc.), with the wall covering produced to the customer's specifications, e.g., run through a digital printer to print the customer's selected or provided pattern and then run through a string lamination press to add the strings or other embellishments.

One consideration across exemplary embodiments is to ensure that the amount and type of backing adhesive is sufficiently strong to handle the added weight of the embellishments.

As discussed above, the applicant/assignee and inventors envision repositionable peel-and-stick embellished wall coverings including grasscloth and similar coverings (e.g., paper weave), for example, by adhering grasscloth or other covering to a peel-and-stick substrate.

One challenge is that grasscloths and similar coverings typically have gaps that can expose the underlying substrate and as well as the adhesive used to adhere the covering to the substrate, especially if the adhesive is applied to the substrate. Therefore, in certain exemplary embodiments, the substrate is dyed, printed, or otherwise colored to match or complement the covering. Also, because typical adhesives dry with a sheen that can ruin the look of a natural covering such as grasscloth or paper weave, certain exemplary embodiments use an adhesive that dries with a matte finish that blends more naturally with the natural covering, e.g., a water-based white latex adhesive made from Polyvinyl Acetate (PVAC) or certain adhesives of the type that is often used in the garment industry to glue cloth with a sponge or silica gel).

Another challenge faced by such products is that most existing substrates (which generally are vinyl) tend to shrink after installation, which not only can leave gaps between adjacent panels but also can cause the grasscloth or other covering to delaminate from the substrate due to deformation of the substrate. Therefore, certain exemplary embodiments use a substrate made from silicon coated paper pulp that is less susceptible to shrinking.

Another challenge faced by such products is that the substrate backing liner tends to shrink and expand along with humidity changes such that every time the product is exposed to a heating process during manufacture, the substrate backing liner can dry out and be susceptible to creasing. Therefore, certain exemplary embodiments apply water to the substrate backing liner after heating processes so that the substrate backing liner can stay hydrated and flexible.

These rehydration processes can raise other challenges. For one example, residual moisture used to condition the substrate backing liner could lead to mold, since grasscloths and similar products (e.g., paper) are made from natural fibers. One possible solution envisioned by the applicant/assignee and inventors is to apply an antifungal agent to the product to prevent mold. For another example, dye color might transfer from the front of the product to the backing liner, particularly when natural water-based dyes are used and the backing liner is moist. One possible solution envisioned by the applicant/assignee and inventors is to add an extra sheet of waterproof liner before rolling in order to avoid direct contact between the front of the product to the backing liner.

The following is a process for fabricating a peel-and-stick sisal grasscloth wallcovering, in accordance with various exemplary embodiments:

1. Dye the sisal grass net to the desired color using natural dye

2. Dry the grass net on heating cylinder

3. Match the print color to the dye

4. Gravure print the substrate

5. Oven Heat the product to dry the print

6. Apply water back to the liner to prevent creasing

7. Apply adhesive to the printed surface

8. Laminate the dyed sisal grass net to the substrate

9. Oven Heat the product to dry the adhesive

10. Apply water back to the liner to prevent creasing

11. Trim the edge

12. Reverse roll the product and shrink wrap to create an even tension to prevent the liner from creasing

Similar techniques can be used to produce other types of peel-and-stick grasscloth wallcoverings including, without limitation, abaca, raffia, ramie, jute, hemp, cattail, bamboo etc. Most of these natural fibers need similar preparation, e.g., harvest, dry, comb, knot, then weave into a net.

It is envisioned that the procedure will be similar to a peel-and-stick paper weave wallcovering, although paper weave is made from paper and therefore it is envisioned that the paper would be pre-printed (e.g., by gravure machine) and then cut into paper thread and woven to form a paper weave net that then can be laminated on to the peel-and-stick substrate.

The manufacturing process itself raises even other challenges. For example, laminating grasscloth or similar covering to a peel-and-stick substrate requires special machinery that can create even tension for the covering (which is fragile) and the substrate (which is slightly resilient) throughout the laminating process. Grasscloth production facilities generally have machinery that is capable of such handling but generally do not have machinery for performing other process steps of the types described above such as dying or printing the substrate, laminating the covering onto the substrate (e.g., by applying adhesive to the substrate and performing the lamination), or drying the product at various process steps, thereby creating a logistical problem that can be solved, for example, by outfitting the grasscloth production facility with dying/printing equipment, laminating equipment, drying equipment, etc. so that the existing grasscloth production equipment can be leveraged on-site.

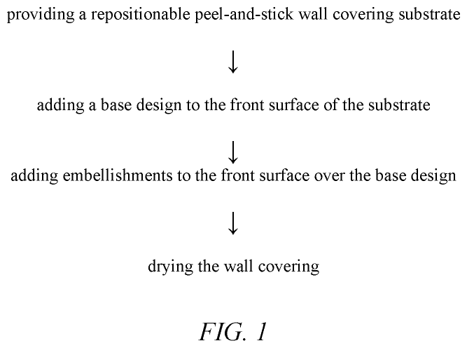

FIG. 1 is a process flow diagram showing a general process for creating a repositionable peel-and-stick embellished wall covering in accordance with various embodiments. Among other things, the process includes providing a repositionable peel-and-stick wall covering substrate having one or more layers of material with a front surface and with a self-adhesive backing covered by a peelable backing material, adding a base design to the front surface of the substrate, adding embellishments to the front surface over the base design including at least one of string, grasscloth, beads, or flock, and drying the wall covering. As discussed above, the substrate may include a removable facing material (e.g., 5 mil vinyl) that is adhered to a backing liner (e.g., a 50# backing liner) using a removable/repositionable backing adhesive (e.g., H-802 adhesive). As discussed above, adding a base design to the front surface of the substrate can include at least one of gravure printing, digital printing, or rotary screen printing a design with one or more inks (e.g., water-based inks) and drying, e.g., using hot air impingement and infrared dryers as the heat source. Adding the embellishments can include applying adhesive to the embellishments and then applying the embellishments with adhesive to the front surface over the base design and/or can include applying adhesive to the front surface over the base design and then applying the embellishments to the front surface with adhesive. The embellishments may include strings (e.g., up to around 27 strings per inch), in which case adding the embellishments may include running the substrate with base design through a string lamination press in which the strings are adhered to the front surface over the base design, e.g., by applying an adhesive to the strings and/or to the front surface, and drying the wall covering comprises using steam drums as the drying source under predetermined process conditions that allow for properly drying the strings and adhesive without damaging the backing liner and backing adhesive (e.g., wherein the steam drums are maintained at a temperature between around 220° F.-240° F. and the product is passed across the steam drums for a total dwell time at each point along the length of the product between around 20-30 seconds for sufficient drying). Adding the embellishments may include using a template for placement of the embellishments and/or using an adhesive that dries with a matte finish, e.g., a water-based white latex adhesive made from Polyvinyl Acetate (PVAC) or certain adhesives of the type that is often used in the garment industry to glue cloth with a sponge or silica gel. The base design may be chosen to match or complement the embellishment so that any spaces between embellishments are less noticeable. The substrate may be made at least in part from silicon coated paper pulp that is less susceptible to shrinking. Water may be applied to the substrate backing liner after a heating process so that the substrate backing liner can stay hydrated and flexible. An antifungal agent may be applied to at least one of the substrate or the embellishments to prevent mold. The completed wall covering may be rolled including an extra sheet of waterproof liner in order to avoid direct contact between the front of the product to the backing liner.

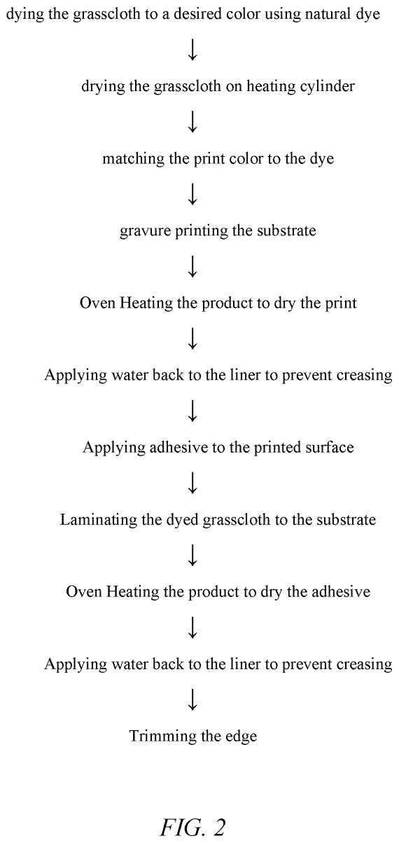

FIG. 2 is a process flow diagram showing a specific process for creating a repositionable peel-and-stick grasscloth wall covering in accordance with various embodiments. Among other things, the process includes dying the grasscloth to a desired color using natural dye; drying the grasscloth on heating cylinder; matching the print color to the dye; gravure printing the substrate; oven heating the product to dry the print; Applying water back to the liner to prevent creasing; applying adhesive to the printed surface; laminating the dyed grasscloth to the substrate; oven heating the product to dry the adhesive; applying water back to the liner to prevent creasing; and trimming the edge.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

1-39. (canceled)

40. A repositionable peel-and-stick wall covering comprising:
a repositionable peel-and-stick wall covering substrate having one or more layers of material with a front surface and with a self-adhesive backing covered by a peelable backing material;
a base design added to the front surface of the substrate; and
embellishments on the front surface over the base design, the embellishments including at least one of strings, grasscloth, beads, or flock.

41. A wall covering according to claim 40, wherein the substrate includes a removable facing material that is adhered to a backing liner using a removable/repositionable backing adhesive.

42. A wall covering according to claim 41, wherein at least one of:
the removable facing material is a vinyl facing material;
the backing liner is a 50# backing liner; or
the removable/repositionable backing adhesive is an H-802 adhesive.

43. A wall covering according to claim 40, wherein the base design comprises at least one of a gravure printed design, a digital printed design, or a rotary screen printed design using one or more inks.

44. A wall covering according to claim 43, wherein the one or more inks are water-based inks.

45. A wall covering according to claim 40, further comprising an adhesive on the embellishments adhering the embellishments on the front surface over the base design.

46. A wall covering according to claim 40, further comprising an adhesive on the front surface over the base design adhering the embellishments on the front surface over the base design.

47. A wall covering according to claim 40, wherein the embellishments include strings laminated via lamination press on the front surface over the base design.

48. A wall covering according to claim 47, further comprising an adhesive applied to the strings adhering the strings to the front surface over the base design.

49. A wall covering according to claim 47, further comprising adhesive is applied to the front surface over the base design and then the strings are adhered to the front surface with adhesive.

50. A wall covering according to claim 47, wherein the wall covering is steam-drum dried such that the strings are dried without damage to the backing liner and backing adhesive.

51. A wall covering according to claim 47, wherein the total threads per inch of strings is around 27 threads per inch.

52. A wall covering according to claim 40, wherein the embellishments are adhered to the front surface over the base design using an adhesive that dries with a matte finish.

53. A wall covering according to claim 52, wherein the adhesive is one of:
a water-based white latex adhesive made from Polyvinyl Acetate (PVAC); or
a matte garment industry adhesive.

54. A wall covering according to claim 40, wherein the base design matches or complements the embellishment so that any spaces between embellishments are obscured.

55. A wall covering according to claim 40, wherein the substrate is made at least in part from silicon coated paper pulp.

56. A wall covering according to claim 41, wherein the backing liner is a rehydrated backing liner.

57. A wall covering according to claim 40, further comprising:
an antifungal agent on at least one of the substrate or the embellishments to prevent mold.

58. A wall covering according to claim 40, wherein the wall covering is rolled including an extra sheet of waterproof liner in order to avoid direct contact between the front of the product to the backing liner.

59. A wall covering according to claim 40, wherein the embellishments include grasscloth, and wherein:
the grasscloth is dyed to a desired color using natural dye;
the base design uses a print color matched to the dye; and
the dyed grasscloth is laminated to the substrate using an adhesive applied to at least one of the grasscloth or the printed surface.
